(19) United States
(12) Patent Application Publication
(10) Pub. No.: US 2007/0124205 A1
(43) Pub. Date: May 31, 2007

(54) Enhanced modem for direct advertising information via an LCD screen

(75) Inventor: Joseph A. Bobier, Sunrise, FL (US)

Correspondence Address: DENNIS L. COOK, ESQ.;THE LAW OFFICES OF DENNIS L COOK PLLC, 12718 DUPONT CIRCLE, TAMPA, FL, 33626, US

(73) Assignee: xG Technology, LLC, Sarasota, FL (US)

(21) Appl. No.: 11/503,474

(22) Filed: Aug. 11, 2006

Related U.S. Application Data
(60) Provisional application No. 60/717,128, filed on Sep. 14, 2005.

(51) Int. Cl. G07G 1/14; G06Q 30/00

(52) U.S. Cl. 705/14

(57) ABSTRACT

This disclosure increases the utility of a modem. An added color LCD gives the modem the added capability of displaying whatever message a given advertiser wishes to display. These messages could contain anything from special offers on products to industry updates. The modem also incorporates a button which transmits a signal to the personal computer itself. This added function allows the user to take advantage of special offers displayed on the LCD, by merely pressing the button on the modem. Once the button is pressed, a signal is be transmitted to the computer, bringing up a window in the user's browser. From this window, the user is navigated to the details involved in the special offer.

### CROSS-REFERENCE TO RELATED APPLICATION

The present application claims the benefit of previously filed co-pending Provisional Patent Application, Ser. No. 60/717,128 filed Sep. 14, 2005.

### FIELD OF INVENTION

This invention relates to a system which allows for a more direct form of presenting advertising information to a computer user, principally through a periphery device plugged into a personal computer. The system takes advantage of common networking devices such as a modem. The device uses the modem as a platform for an LCD display, which communicates to the user the message which a subscriber to the service wishes to display. The user may choose to pursue the opportunity or simply do nothing. The device allows user interface through a response button on said device, acting as an immediate response network for the user and advertiser.

### BACKGROUND OF INVENTION

Modems have become common devices for PC users. They have, until now, been utilized only as digital conversion devices. Typically, the only visual aspect of the modem, is an LED that tells the user whether the modem is running, or not running. When they are not being stored under the desk, or in a drawer, they often become space-eating objects with no use to the users desktop.

### BRIEF SUMMARY OF THE INVENTION

This invention aims at increasing the capabilities of a modem as a periphery device. By incorporating a screen into the design of a modem, this invention increases the utility of the modem. The color LCD gives the modem the added capability of displaying whatever message a given advertiser wishes to display. These messages could contain anything from special offers on products to industry updates.

The modem also incorporates a button which would transmit a signal to the personal computer itself. This added function allows the user to take advantage of special offers displayed on the LCD, by merely pressing the button on the modem. Once the button is pressed, a signal would be transmitted to the computer, bringing up a window in the user's browser. From this window, the user would be navigated to the details involved in the special offer.

It is therefore an object of the invention to supply increased functionality to a modem allowing real time viewing of advertising on a LCD screen and easy selection of the offer by a user.

### BRIEF DESCRIPTION OF DRAWINGS

For a fuller understanding of the nature and objects of the invention, reference should be made to the following detailed description, taken in connection with the accompanying drawings, in which:

FIG. 1: Software Model of LCD Communication at Modem;

FIG. 2: Flowchart of SW application at the network operator's server to transfer ads, coupons, and headline news to subscriber;

FIG. 3: Flowchart of SW processes at subscriber modem to display status of connectivity, ads, and headline news; and,

FIG. 4: Flowcharts for SW processes (a) and (b) at the subscriber's modem that handles an interrupt from the “tell me more” button.

### DESCRIPTION OF PREFERRED EMBODIMENT

The hardware setup is as follows: a subscriber's PC is connected to a modem via a 10/100T port and a serial or USB port. The service provider is referred to as network operator. The software applications are implemented at three platforms: the modem box, the subscriber's PC, and the network operator's server.

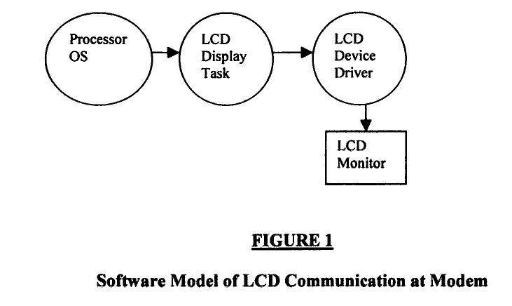

The software running on the modem will contain a driver for the LCD monitor and a LCD display task. This is shown in FIG. 1.

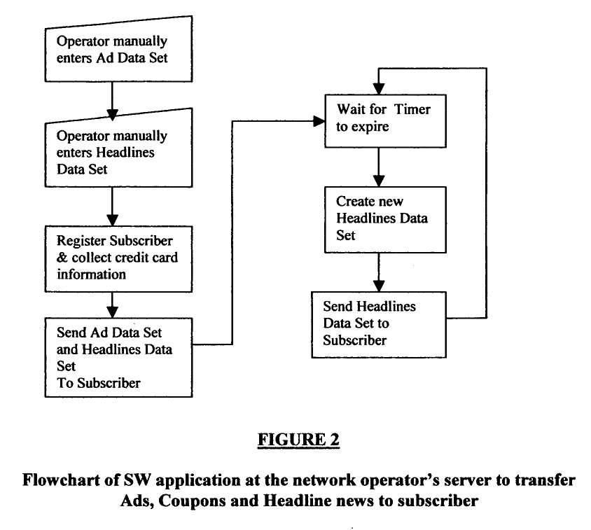

The application at the network operator's server will create the data set that contains the headline news, the ads, and coupons that have been paid for by companies wishing to do advertising. When a new subscriber registers with the network operator, this data set is downloaded to the subscriber's modem. The operator will already have on file all the necessary information for the subscriber to purchase items, like credit card number, delivery address etc. After initial registration, the headlines and sports news are updated periodically, and sent to the subscriber's modem. This process is shown in FIG. 2.

The network operator will maintain one web page for each ad and each headline news or sports news (For example, if there are 5 ads, and 3 news items, then there will be 8 web pages.). Each of these web pages is identified to software by a unique web page address, referred to as webPageAddr. Every ad or news item will have an identifier called dispID. Thus, every item displayed can uniquely be identified by the dispID and webPageAddr. The data set sent to the subscriber's modem will contain the dispID and the webPageAddr for every display item.

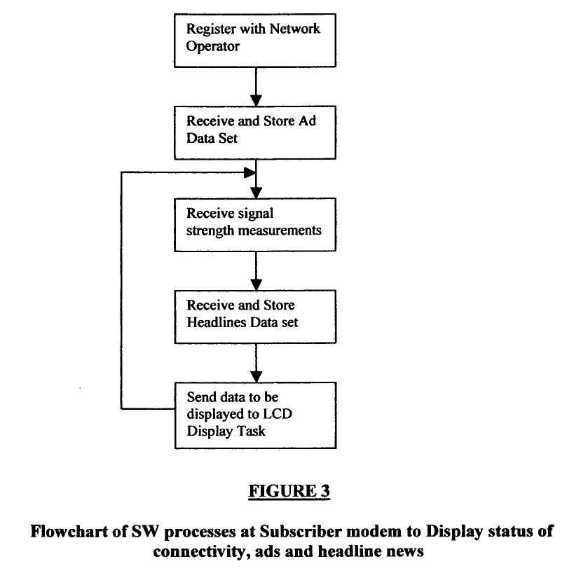

The modem software will route all ads and news data to the LCD display task. Any data related to signal strength and connectivity will also be routed to the LCD display task periodically and will be displayed on the LCD monitor. This process is shown in FIG. 3.

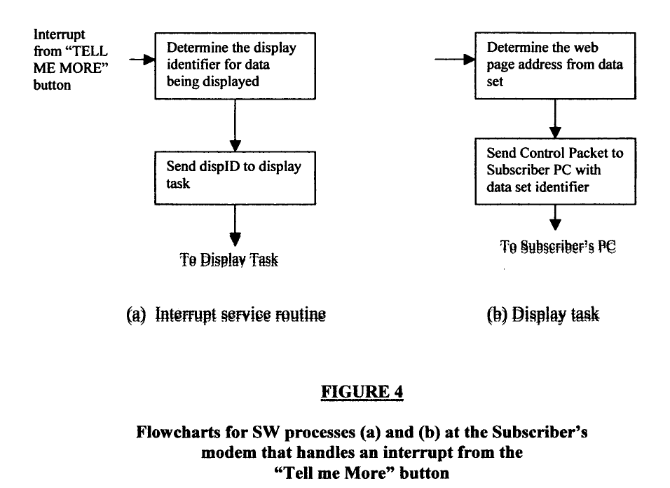

When the subscriber pushes an activation device, such as a “Tell me More” button, on the modem box, a hardware interrupt is generated. This interrupt is serviced by the modem software's Interrupt Service Routine (ISR), which determines the identifier of the item on display (dispID) when the button was pushed. This dispID is sent to the modem software's Display task. The Display task will retrieve the webPageAddr, using the dispID given. A control packet is created with the webPageAddr embedded in the packet. This control packet is sent to the subscriber's PC. This procedure is shown in FIG. 4.

When the application on the subscriber's PC receives the control packet, it retrieves the web page address from webPageAddr. A web browser is launched, and the retrieved web page is opened. If a headline news item or sports news item was displayed when the “Tell Me More” button was pushed, then the web page that is opened on the subscriber's PC takes the subscriber directly to that particular news item. If an advertisement was displayed when the “Tell Me More” button was pushed, then the web page that is opened takes the subscriber directly to the details of that particular advertisement. This web page has a “Buy Now” button, to allow the subscriber to purchase the item on sale. The subscriber does not need to fill in any billing information, since this information is already on file with the network operator. The subscriber can purchase the item by simply clicking the “Buy Now” button, leading to a “one click buy”. The item will be delivered to the delivery address on file.

This concept saves the subscriber time needed to surf multiple news websites, or sale items, and entering billing information for every purchase. If the subscriber sees a news item of interest on the LCD display, he/she can read more by a single push of the “Tell Me More” button. If the subscriber sees an item he/she wishes to buy on the LCD display all that is required is one push of the “Tell Me More” button, and one click of the “Buy Now” button.

Since certain changes may be made in the above described enhanced modem without departing from the scope of the invention herein involved, it is intended that all matter contained in the description thereof or shown in the accompanying figures shall be interpreted as illustrative and not in a limiting sense.

What is claimed is:

1. A system for displaying advertising or news items on a modem and completing a purchase or getting more information about the news item through a computer comprising:
a modem;
said modem having a display screen;
said modem having an activation device;
a subscriber's personal computer;
said subscriber's personal computer in communication with said modem;
said subscriber's personal computer having a web browser;
a network operator's server;
said network operator's server being in communication with said modem;
said network operator's server maintaining a web page for an advertisement, a headline news item, a sports news item, or the like; and,
said modem displaying on said display screen said advertisement, said headline news item, said sports news item, or the like in a rotational manner such that when a subscriber activates said activation device on said modem during the display of said advertisement, said headline news item, said sports news item, or the like the activation launches said web browser on said subscriber's personal computer and displays said web page for said advertisement, said headline news item, said sports news item, or the like allowing subscriber to purchase an item from said advertisement, or read said headline news item, said, sports news item, or the like.

2. The system of claim 1 wherein said display screen on said modem is an LCD display.

3. The system of claim 1 wherein said activation device on said modem is a button.

4. The system of claim 1 wherein the subscriber's purchase information such as credit card and delivery information is stored in said network operator's server such that the subscriber can purchase an item from said advertisement by clicking on said advertisement displayed in said web browser.
